(19) United States
(12) Patent Application Publication
(10) Pub. No.: US 2016/0208099 A1
(43) Pub. Date: Jul. 21, 2016

(54) A PHENALKAMINE COMPOSITION

(71) Applicants: Hanbang DONG, Midland, MI (US); Wei ZHOU, Midland, MI (US); Rajesh TURAKHIA, Midland, MI (US); Lei YAN, Midland, MI (US); BLUE CUBE IP LLC, Midland, MI (US); Yi ZHANG, Midland, MI (US)

(72) Inventors: Yi ZHANG, Shanghai (CN); Hanbang DONG, Shanghai (CN); Wei ZHOU, Shanghai (CN); Rajesh TURAKHIA, Lake Jackson, TX (US); Lei YAN, Shanghai (CN)

(21) Appl. No.: 14/913,552

(22) PCT Filed: Aug. 29, 2013
(86) PCT No.: PCT/CN2013/082524

§ 371 Date: Feb. 22, 2016

(51) Int. Cl. C08L 95/00; C08G 14/06

(52) U.S. Cl. CPC C08L 95/005; C08G 14/06

(57) ABSTRACT

A novel phenalkamine composition capable of emulsifying asphalt to form a stable asphalt emulsion composition; a curable asphalt composition comprising such asphalt emulsion composition and a waterborne epoxy resin showing improved pull-off adhesion strength from a substrate; and a process of preparing the phenalkamine composition.

### FIELD

The present invention relates to a phenalkamine composition, a process of preparing such phenalkamine composition, an asphalt emulsion composition and a curable asphalt composition comprising such phenalkamine composition.

### INTRODUCTION

Asphalt emulsions are widely used in road paving and maintenance applications such as tack coats, fog seals, slurry seals and micro-surfacing. During application, aggregates and other additives (for example, fillers and dispersants) are usually added into the asphalt emulsion to obtain a pavement. However, the resultant pavement tends to deform or crack under repeated loadings.

To address the above mentioned problems, conventional rubbers such as styrene-butadiene rubber (SBR) latex or styrene-butadiene-styrene (SBS) copolymers are commonly used to modify asphalt emulsions. Rubber-modified asphalt emulsions are usually supplied in one-component or two-component systems. Compared to unmodified asphalt emulsions, rubber-modified asphalt emulsions, upon drying, can provide better adhesion to a substrate and/or aggregates, which is a critical attribute for improving the durability and maintenance life of paved road surfaces. However, rubber-modified asphalt emulsions still deform after repeated use, especially in the summer when the temperature of road surfaces sometimes reaches as high as 50 to 60° C. Moreover, rubber-modified asphalt-paved road surfaces usually suffer from aging problems.

Another common approach to modify asphalt emulsions is to mix asphalt emulsions with waterborne epoxy resins and conventional water-soluble amine hardeners. Asphalt and epoxy resins are known to be incompatible, so the combination of asphalt and epoxy resin is usually not able to form an emulsion stable enough for storage, processing and transportation to meet industrial requirements such as the JTG E20-2011 industry standard in China (hereinafter “the JTG E20-2011 standard”). Therefore, conventional waterborne epoxy-modified asphalt compositions are usually supplied in a three-component system: an asphalt emulsion, a waterborne epoxy resin and a hardener. These three components are usually stored separately in different tank cars or storage containers, and then mixed on-site at the time of application. These known epoxy-modified asphalt compositions are unable to be applied using existing conventional equipment and vehicles that are normally used for one-component or two-component rubber-modified asphalt emulsions described above. Hence, the use of epoxy-modified asphalt compositions with existing conventional equipment results in a significant increase in the amount of labor and equipment; and cost.

### SUMMARY

The present invention provides inter alia (1) a novel composition that can emulsify asphalt so as to provide a stable asphalt emulsion composition; (2) a modified curable asphalt composition that can provide paved road surfaces with beneficial properties such as enhanced durability, maintenance life and thermal resistance relative to conventional rubber-modified asphalt emulsions; and (3) a modified curable asphalt composition that can be applied using conventional available equipment and vehicles commonly used for conventional rubber-modified asphalt emulsions.

Surprisingly, the novel phenalkamine composition of the present invention can provide an asphalt emulsion composition with satisfactory stability, which does not require the use of a conventional emulsifier. “Satisfactory stability” herein means that the solids content difference for the asphalt emulsion composition is less than 1% after one-day storage at room temperature (20 to 25° C.), less than 1% after one-day storage at 60° C., and less than 5% after 5-day storage at room temperature as measured by the T0655-1993 method described in the JTG E20-2011 standard.

A curable asphalt composition comprising such asphalt emulsion composition and a waterborne epoxy resin can be prepared and applied using conventional available equipment for a two-component system. The curable asphalt composition of the present invention can be prepared by combining the asphalt emulsion composition and the waterborne epoxy resin upon application. Compared to conventional rubber-modified asphalt emulsions, the curable asphalt composition of the present invention, upon curing, provides higher pull-off adhesion strength from an asphalt or concrete substrate at room temperature, and in particular, at a temperature (e.g., 50 to 60° C.) higher than room temperature.

In a first aspect, the present invention is a phenalkamine composition comprising the reaction product of:
(a) an aldehyde,
(b) a polyamine having a hydrophilic-lipophilic balance value of 11 or less, and
(c) cashew nut shell liquid comprising cardol and polymerized materials of cardanol, cardol, or mixtures thereof; wherein the total content of cardol and the polymerized materials is at least 20 weight percent (wt %), based on the total weight of the cashew nut shell liquid.

In a second aspect, the present invention is a process of preparing the phenalkamine composition of the first aspect. The process comprises:
providing (a) an aldehyde, (b) a polyamine having a hydrophilic-lipophilic balance value of 11 or less, and (c) cashew nut shell liquid comprising cardol and polymerized materials of cardanol, cardol, or mixtures thereof; wherein the total content of cardol and the polymerized materials is at least 20 wt %, based on the total weight of the cashew nut shell liquid; and
reacting the aldehyde, the polyamine, and the cashew nut shell liquid to form the phenalkamine composition.

In a third aspect, the present invention is an asphalt emulsion composition comprising (i) the phenalkamine composition of the first aspect, (ii) at least one acid, (iii) water, and (iv) asphalt.

In a fourth aspect, the present invention is a process of preparing the asphalt emulsion composition of the third aspect. The process comprises admixing (i) the phenalkamine composition of the first aspect, (ii) at least one acid, (iii) water, and (iv) asphalt.

In a fifth aspect, the present invention is a curable asphalt composition comprising (A) the asphalt emulsion composition of the third aspect, and (B) a waterborne epoxy resin having a solids content.

In a sixth aspect, the present invention is a process of preparing a curable asphalt composition of the fourth aspect. The process comprises admixing (A) an asphalt emulsion composition comprising (i) the phenalkamine composition of the first aspect, (ii) at least one acid, (iii) water, and (iv) asphalt; and (B) a waterborne epoxy resin having a solids content.

### DETAILED DESCRIPTION

The phenalkamine composition of the present invention comprises the reaction product of an aldehyde, a polyamine, and a specific cashew nut shell liquid (“CNSL”) via the Mannich reaction (aminomethylation).

CNSL used to prepare the phenalkamine composition of the present invention comprises cardol. Cardol has the following structure:

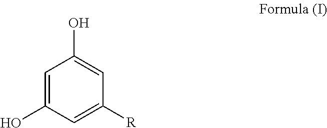

wherein R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; or a straight-chain alkyl with 17 carbons containing 1 to 3 C═C bond(s) selected from the group consisting of —C₁₇H₃₃, —C₁₇H₃₁, and —C₁₇H₂₉.

The concentration of cardol in CNSL may be, based on the total weight of CNSL, 3 wt % or more, 7 wt % or more, 10 wt % or more, or even 13 wt % or more, and at the same time, 90 wt % or less, 70 wt % or less, 50 wt % or less, 30 wt % or less, or even 25 wt % or less. The concentration of components of CNSL is determined by gas chromatography equipped with flame ionization detector (GC-FID) described in the Examples section below.

CNSL used to prepare the phenalkamine composition of the present invention also comprises polymerized materials of cardanol, cardol, or mixtures thereof. Cardanol herein refers to a mixture of phenols which contain one hydroxyl group and differ in the number of C═C bonds in the aliphatic side chain in the meta-position. The structure of cardanol is shown as follows:

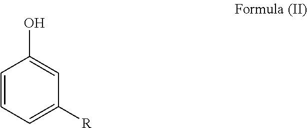

wherein R is as previously defined with reference to Formula (I).

The polymerized materials in CNSL may comprise dimers of cardanol, trimers of cardanol, dimers of cardol, trimers of cardol, oligomers of cardol, oligomers of cardanol; their isomers; or mixtures thereof. Trienes of cardol and/or cardanol may react under a succession of autocatalyzed polymerization reactions under heating. The C═C double bond(s) in the R group of cardol and/or cardanol may undergo isomerisation to isomers with conjugated trans double bonds. These isomers may be dimersed into Diels-Alder adducts. The Diels-Alder adducts may be further polymerized with cardanol and/or cardol, wherein C═C double bond(s) are further consumed. The polymerized materials may comprise dimers of cardanol having the chemical formula of C₄₂H₆₀O₂ and their isomers, dimers of cardol having the chemical formula of C₄₂H₆₀O₄ and their isomers, or mixtures thereof. The polymerized materials can also be formed through auto-oxidation reactions of cardanol, cardol, or mixtures thereof.

The polymerized materials in CNSL may have a polystyrene equivalent weight average molecular weight of 620 or higher, 700 or higher, 750 or higher, or even 800 or higher, and at the same time, 8,000 or lower, 6,000 or lower, 4,000 or lower, or even 2,000 or lower, according to gel permeation chromatography (GPC) analysis described in the Examples section below.

The concentration of the polymerized materials in CNSL may be, based on the total weight of CNSL, 1 wt % or more, 3 wt % or more, 5 wt % or more, or even 10 wt % or more, and at the same time, 97 wt % or less, 70 wt % or less, 50 wt % or less, or even 30 wt % or less.

The total content of cardol and the polymerized materials in CNSL may be, based on the total weight of CNSL, 20 wt % or more, 25 wt % or more, or even 30 wt % or more, and at the same time, 97 wt % or less, 80 wt % or less, 60 wt % or less, or even 50 wt % or less.

CNSL used to prepare the phenalkamine composition of the present invention may further comprise cardanol. When present, the concentration of cardanol in CNSL may be 10 wt % or more, 40 wt % or more, or even 60 wt % or more, and at the same time, 80 wt % or less, 75 wt % or less, or even 70 wt % or less.

CNSL used to prepare the phenalkamine composition of the present invention may be produced by decarboxylation of natural CNSL through a heating step, which leads to the formation of the polymerized materials of cardanol, cardol, or mixtures thereof. Natural CNSL is a liquid that typically comprises approximately 70 wt % of anacardic acid, 18 wt % of cardol, and 5 wt % of cardanol, based on the total weight of the natural CNSL. The heating step may be conducted at a temperature from 160 to 220° C., or from 180 to 200° C. Suitable commercially available CNSL useful for preparing the phenalkamine composition may include technical CNSL and distilled technical CNSL both available from Huada Saigao (Yantai) Science & Technology Company Limited. In one embodiment, CNSL used to prepare the phenalkamine composition of the present invention comprises from 65 to 75 wt % of cardanol, from 5 to 15 wt % of cardol, and from 15 to 25 wt % of the polymerized materials, based on the total weight of CNSL.

The aldehyde used to prepare the phenalkamine composition of the present invention can be formalin solution, paraformaldehyde, formaldehyde, any substituted aldehyde, or mixtures thereof. In a preferred embodiment, the aldehyde used in the present invention can be formaldehyde.

The polyamine used to prepare the phenalkamine composition of the present invention can have a hydrophilic-lipophilic balance (HLB) value of 11 or less, 8 or less, or even 6 or less. HLB value herein is determined according to the Griffin Formula: HLB=20*Mh/M, wherein Mh is the molecular mass of the hydrophilic portion of a molecule and M is the molecular mass of the whole molecule (“Calculation of HLB Values of Non-Ionic Surfactants”, Journal of the Society of Cosmetic Chemists 5 (4): 249-56, 1954). The polyamine may be an aliphatic diamine, an aromatic diamine, a polyamide, a cycloaliphatic polyamine, a polycyclic polyamine, a polyamidoamine, or mixtures thereof. The aliphatic diamine may be a diamine containing an aliphatic ethylene group having the structure of —(CH₂)ₘ—, wherein m is from 1 to 10, or from 1 to 5. Examples of suitable aliphatic diamines include ethylenediamine (EDA), diethylenediamine, or mixtures thereof. The aromatic diamines may be m-xylylenediamine (MXDA). Examples of suitable cycloaliphatic polyamines include isophorone diamine (IPDA); 1,3-cyclohexanebis(methylamine) (1,3-BAC); 4,4′-methylenebis(cyclohexylamine) (PACM); or mixtures thereof. Preferably, the phenalkamine composition of the present invention is the Mannich reaction product of CNSL with formaldehyde, and a polyamine selected from ethylenediamine, diethylenediamine, or mixtures thereof.

The phenalkamine composition of the present invention can be prepared according to the Mannich reaction conditions known in the art. The phenalkamine composition may be prepared by providing the aldehyde, the polyamine and CNSL described above, and reacting them via the Mannich reaction to form the phenalkamine composition. Solvents such as benzene, toluene or xylene can be used for removal of water produced during this reaction at an azeotropic distillation point. Nitrogen is also recommended for easing the water removal. The reaction may be conducted at a temperature from 60 to 130° C., or from 80 to 110° C. The initial molar ratio of CNSL:aldehyde:polyamine for preparing the phenalkamine composition can vary in the range of 1.0: 1.0-3.0: 1.0-3.0, or in the range of 1.0: 1.4-2.4: 1.4-2.2. In some embodiments, CNSL and the polyamine are mixed, and then the aldehyde is added into the resulting mixture. Time duration for adding the aldehyde can vary in the range of from 0.5 to 2 hours, or from 0.6 to 1 hour.

The phenalkamine composition of the present invention can be used as an emulsifier. When used as an emulsifier, the phenalkamine composition can be mixed with sufficient acid and water to form a cationic emulsifier. The phenalkamine composition is particularly useful in emulsifying asphalt.

The phenalkamine composition of the present invention is also useful as a hardener for curing a compound containing a functional group reactive with active hydrogen in the phenalkamine composition. In particular, the phenalkamine composition can be used as a hardener for curing an epoxide group-containing compound.

The asphalt emulsion composition of the present invention comprises (i) the phenalkamine composition described above, (ii) at least one acid, (iii) water, and (iv) asphalt. The concentration of the phenalkamine composition may be, based on the total weight of the asphalt emulsion composition, 0.05 wt % or more, 0.1 wt % or more, or even 0.2 wt % or more, and at the same time, 15 wt % or less, 6 wt % or less, or even 2 wt % or less.

The asphalt useful in the present invention may be any asphalt known in the art, or mixtures of different types of asphalt. Examples of suitable asphalt include heavy traffic asphalt such as AH-70 or AH-90 asphalt, polymer-modified asphalt such as SBS- or SBR-modified asphalt, or mixtures thereof. Asphalt is usually a sticky, black and highly viscous liquid or semi-solid form of petroleum. The asphalt useful in the present invention may have a needle penetration at 25° C. of from 40 to 100 decimillimeters (dmm), from 50 to 90 dmm, or from 60 to 90 dmm according to the T0604-2011 method described in the JTG E20-2011 standard.

Suitable commercially available asphalt useful in the present invention may include, for example, Zhonghai 70^{#} asphalt, Zhonghai 90^{#} asphalt, Donghai 70^{#} asphalt, and Donghai 90^{#} asphalt all available from Sinopec; AH-70 asphalt and AH-90 asphalt both available from Shell; or mixtures thereof.

The concentration of the asphalt may be, based on the total weight of the asphalt emulsion composition, 10 wt % or higher, 45 wt % or higher, or even 50 wt % or higher, and at the same time, 70 wt % or lower, 65 wt % or lower, or even 60 wt % or lower.

The asphalt emulsion composition of the present invention also comprises an acid such as an inorganic acid, an organic acid, or mixtures thereof. Preferably, an inorganic acid is used. Examples of suitable inorganic acids include hydrochloric acid (HCl), phosphoric acid, nitric acid or mixtures thereof. The organic acid may be selected from formic acid, acetic acid, acrylic acid, succinic acid, malonic acid, oxalic acid, tartaric acid, citric acid or mixtures thereof. Preferably, hydrochloric acid or oxalic acid is used. The acid can be in an amount sufficient to achieve a suitable pH value. For example, the pH value of an emulsion comprising the phenalkamine composition described above, the acid and water is generally from 1.5 to 3, from 1.7 to 2.5, or from 1.8 to 2.2.

The asphalt emulsion composition of the present invention also comprises water.

The asphalt emulsion composition of the present invention may be free of, or further comprise one or more emulsifiers known in the art. The emulsifiers can be a cationic emulsifier, a nonionic emulsifier, or a mixture of a cationic emulsifier and a nonionic emulsifier. Preferably, the emulsifier comprises one or more cationic emulsifiers. The cationic emulsifier may comprise an amine, and preferably a quaternary amine Examples of suitable cationic emulsifiers include polyamines; imidazolines; alkyl betaines; alkylamido detaines; reaction products of polyamines with polycarboxylic acids, anhydrides or sulfonated fatty acids, their quaternization products; polyalkanol amines, their esterification products; mixtures of polyalkanol amines and carboxylic acids; quaternization products of polyalkanol amines, quaternization products of polyalkanol amines' esterification products; polyalklene amines, their reaction products with kraft lignin or maleinized lignin; or mixtures thereof. Examples of suitable nonionic emulsifiers include octylphenol ethoxylates, nonylphenol ethoxylates, dodecylphenol ethoxylates, or mixtures thereof.

Suitable commercially available emulsifiers useful in the present invention include, for example, INDULIN™ MQK-1M and INDULIN MQ3 emulsifiers available from MeadWestvaco Corporation, REDICOTE™ E4819 and REDICOTE EM44 emulsifiers available from Akzo Nobel, or mixtures thereof.

When used, the emulsifier can be used in an amount known in the field. The concentration of the emulsifier may be, based on the total weight of the asphalt emulsion composition, 0.01 wt % or more, 0.05 wt % or more, or even 0.1 wt % or more, and at the same time, 5 wt % or less, 3 wt % or less, 2 wt % or less, or even 1.6 wt % or less.

Preferably, the asphalt emulsion composition of the present invention is substantially free of any conventional emulsifiers. More preferably, the asphalt emulsion composition of the present invention is free of any conventional emulsifiers, wherein the phenalkamine composition described above acts as an emulsifier in the asphalt emulsion composition. The phenalkamine composition can emulsify the asphalt, which does not require the use of any conventional emulsifiers. The asphalt emulsion composition of the present invention surprisingly has satisfactory stability. Solids content difference for the asphalt emulsion composition is less than 1% after one-day storage at room temperature, less than 1% after one-day storage at 60° C., and less than 5% after 5-day storage at room temperature as measured by the T0655-1993 method described in the Examples section below.

The process of preparing the asphalt emulsion composition of the present invention may comprise admixing (i) the phenalkamine composition, (ii) the acid, (iii) water, and (iv) the asphalt. The asphalt emulsion composition of the present invention may be prepared by (I) mixing the phenalkamine composition, the acid, water and if present, the emulsifier to form an emulsion; (II) separately heating asphalt; (III) mixing the separately heated asphalt and the emulsion obtained from step (I) to form the asphalt emulsion composition of the present invention. Preferably, preparation of the asphalt emulsion composition is conducted in the absence of an emulsifier. In the step (I) of preparing the asphalt emulsion composition of the present invention, the phenalkamine composition, the acid, water and if present, the emulsifier can be mixed in any order. Preferably, the emulsifier is firstly mixed with the phenalkamine composition, followed by mixing with water. The acid is then added to form the emulsion. The emulsion obtained from the step (I) may have a pH value of from 1.5 to 3, from 1.7 to 2.5, or from 1.8 to 2.2. Components of the asphalt emulsion composition typically mixed and dispersed at a temperature enabling the preparation of a well-dispersed emulsion. Before mixing with the asphalt, the emulsion obtained from the step (I) may be heated to a temperature of 40° C. or higher, 50° C. or higher, or even 60° C. or higher, and at the same time, 90° C. or lower, 85° C. or lower, or even 80° C. or lower. The asphalt in step (II) can be heated to 120° C. or higher, or even 140° C. or higher.

The process of preparing the asphalt emulsion composition of the present invention may be a batch or a continuous process. The mixing equipment used in the process may be any vessel and ancillary equipment well known to those skilled in the art, for example, a colloid mill.

The present invention also provides a method for emulsifying asphalt in water. The method may comprise admixing the phenalkamine composition of the present invention, the acid, water and the asphalt described above. Preferably, the phenalkamine composition, the acid, and water are mixed to form an emulsion before mixing with the asphalt. The method of emulsifying asphalt is preferably conducted in the absence of an emulsifier.

The curable asphalt composition of the present invention comprises (A) the asphalt emulsion composition described above, and (B) a waterborne epoxy resin. The phenalkamine composition may be present in an amount sufficient to emulsify, cure and/or partially cure the waterborne epoxy resin in the curable asphalt composition. The equivalent ratio of epoxy group in the waterborne epoxy resin to active hydrogen in the phenalkamine composition may be 1:0.5 or lower, 1:0.6 or lower, 1:0.7 or lower, or even 1:0.8 or lower, and at the same time, 1:2 or higher, 1:1.5 or higher, 1:1.2 or higher, 1:1.1 or higher, or even 1:1 or higher.

The waterborne epoxy resin, or epoxide group-containing compound, that is curable with the above phenalkamine composition can be selected from any conventional, water-dispersible epoxy compounds. The waterborne epoxy resin can be a dispersion of a liquid epoxy resin, a dispersion of a solid epoxy resin, or a dispersion of a mixture of a liquid epoxy resin and a solid epoxy resin. Preferably, the waterborne epoxy resin is a dispersion of a solid epoxy resin.

The waterborne epoxy resin useful in the present invention can be a self-emulsified epoxy resin. The self-emulsified epoxy resin may be in the form of an aqueous dispersion. The self-emulsified epoxy resin can be an adduct of an epoxy compound with a hydrophilic monomer or polymer containing at least one group selected from carboxyl, hydroxyl, sulfonate group, ethylene oxide group or amino group.

The waterborne epoxy resin useful in the present invention can be an emulsion or a dispersion of one or more epoxy compounds and a surfactant. The epoxy compounds can be solid epoxy resins or liquid epoxy resins. The epoxy compound may include, for example, epoxy resins based on reaction products of polyfunctional alcohols, phenols, cycloaliphatic carboxylic acids, aromatic amines, or aminophenols with epichlorohydrin. Examples of suitable epoxy compounds include bisphenol A diglycidyl ether, bisphenol F diglycidyl ether, resorcinol diglycidyl ether, triglycidyl ethers of para-aminophenols, and reaction products of epichlorohydrin with o-cresol novolacs, hydrocarbon novolacs, phenol novolacs or mixtures thereof. Suitable commercially available epoxy compounds may include, for example, D.E.R.™ D.E.R. 332, D.E.R. 334, D.E.R. 337, D.E.N.™ 431, D.E.N. 438, D.E.R. 671 or D.E.R. 852 epoxy resins all available from The Dow Chemical Company (D.E.R. and D.E.N are trademarks of The Dow Chemical Company).

The surfactant useful herein can be a nonionic or ionic surfactant, which is used to emulsify the epoxy compounds described above in water. Preferably, the surfactant in the waterborne epoxy resin is a nonionic surfactant containing at least one epoxy group, which can react with reactive hydrogen in a hardener. Preferably, the waterborne epoxy resin is a dispersion of a nonionic emulsified epoxy resin.

The waterborne epoxy resin useful in the present invention may have an epoxide equivalent weight (EEW) of 150 or higher, 200 or higher, 300 or higher, or even 350 or higher, and at the same time, 750 or lower, 600 or lower, 550 or lower, 500 or lower, or even 450 or lower. The waterborne epoxy resin may be in the form of a dispersion or an emulsion having a solids content of 40 wt % or higher, 45 wt % or higher, or even 50 wt % or higher, and at the same time, 99 wt % or lower, 90 wt % or lower, 80 wt % or lower, 70 wt % or lower, or even 65 wt % or lower, based on the total weight of the waterborne epoxy resin.

The amount of the waterborne epoxy resin in the curable asphalt composition may be dependent on the concentration of asphalt. The weight ratio of solids of the waterborne epoxy resin to the asphalt may be 0.01:1 or higher, 0.02:1 or higher, 0.04:1 or higher, or even 0.05:1 or higher, and at the same time, 10:1 or lower, 5:1 or lower, 1:1 or lower, or even 0.5:1 or lower.

The curable asphalt composition of the present invention may also comprise aggregates. Aggregates are usually used for many applications such as micro-surfacing or slurry seal. “Aggregates” herein refers to a broad category of coarse particulate material used in construction, including for example sand, gravel, crushed stone, slag, recycled concrete, geosynthetic aggregates or mixtures thereof. Aggregates may be selected from dense-graded aggregates, gap-graded aggregates, open-graded aggregates, reclaimed asphalt pavement or combinations thereof. When used, the aggregates are generally in an amount of from 70 to 99 wt %, from 80 to 95 wt %, or from 85 to 90 wt %, based on the total weight of the curable asphalt composition.

In addition to the foregoing components, the curable asphalt composition of the present invention can further comprise, or be free of, any one or combination of the following additives: styrene copolymers such as SBR and SBS, dispersants, stabilizers, curing promoters, adhesion promoters, pigments, other hardeners, anti-rutting agents, anti-stripping agents, flow modifiers, and fillers such as cement. These additives are generally in an amount of 0 to 10 wt %, from 0.1 to 5 wt %, or from 0.2 to 1 wt %, based on the total weight of the curable asphalt composition.

The process of preparing the curable asphalt composition of the present invention may comprise admixing (A) the asphalt emulsion composition, (ii) the acid, (iii) water, and (iv) the asphalt; and (B) the waterborne epoxy resin. Preferably, the curable asphalt composition of the present invention is prepared by (I) mixing, the phenalkamine composition, the acid, water and if present, the emulsifier described above to form an emulsion; (II) separately heating asphalt; (III) mixing the separately heated asphalt and the emulsion obtained from step (I) to form an asphalt emulsion composition; (IV) mixing the asphalt emulsion composition and a waterborne epoxy resin to obtain the curable asphalt composition. Steps for preparing the asphalt emulsion composition are substantially the same as described above. Preferably, no emulsifier is used when preparing the asphalt emulsion composition, and the phenalkamine composition acts as both a hardener and an emulsifier in the curable asphalt composition. The asphalt emulsion composition obtained from step (III) is typically cooled down to room temperature before mixing with the waterborne epoxy resin. In large-scale industry production, it usually takes 1 day for the asphalt emulsion composition to cool down to room temperature. The asphalt emulsion composition has satisfactory stability at 60° C. to ensure that the emulsion will not break during processing.

The process of preparing the curable asphalt composition of the present invention may comprise another step (V): adding aggregates to the curable asphalt composition obtained from step (IV).

The process of preparing the curable asphalt composition of the present invention may be a batch or a continuous process. The mixing equipment used in the process may be any vessel and ancillary equipment well known to those skilled in the art, for example, a colloid mill.

In one embodiment, the curable asphalt composition of the present invention is prepared by firstly preparing an emulsion that comprises the phenalkamine composition, the acid, water and if present, the emulsifier described above. The resulting emulsion and heated asphalt are then pumped into a colloid mill with high-shear mixing, so as to form an asphalt emulsion composition having asphalt droplets dispersed therein. The obtained asphalt emulsion composition is then mixed with the waterborne epoxy resin described above to form the curable asphalt composition of the present invention.

The curable asphalt composition of the present invention can be supplied in two parts: a “Part A” (asphalt emulsion composition) and a “Part B” (waterborne epoxy resin). The process for preparing the curable asphalt composition of the present invention includes admixing Part A and Part B upon application. Other optional ingredients described above may be added to during or prior to the mixing of Part A and Part B to form the curable asphalt composition. The preparation of the curable asphalt composition can be achieved by blending, in known mixing equipment, the asphalt emulsion composition and the waterborne epoxy resin.

Curing the curable asphalt composition of the present invention may be carried out at a predetermined temperature and for a predetermined period of time sufficient to cure the curable asphalt composition. The temperature of curing the curable asphalt composition is generally from -10 to 300° C., from -5 to 190° C., from 20 to 175° C., or from 21 to 50° C. The time of curing the curable asphalt composition may be chosen between 1 minute to 24 hours, between 5 minutes to 12 hours, or between 30 minutes to 2 hours. It is also operable to partially cure the curable asphalt composition and then complete the curing process at a later time. Upon curing, the curable asphalt composition of the present invention is able to provide higher pull-off adhesion strength at room temperature or at 60° C. than that of a conventional rubber-modified asphalt emulsion such as a SBR-modified asphalt emulsion.

The curable asphalt composition of the present invention may be used in various applications, for example, as water-proofing material for architecture, as coatings such as anti-corrosion coating, and in road paving and maintenance applications. In particular, the curable asphalt composition is suitable for use in road paving and maintenance applications such as tack coats, fog seals, slurry seals and micro-surfacing. The curable asphalt composition can be supplied with conventional equipment commonly used for a two-component system. During application, Part A (the asphalt emulsion composition) and Part B (the waterborne epoxy resin) are stored in two different tanks, mixed on-site, and optionally mixed with other optional components in the curable asphalt composition such as aggregates, then applied to a substrate such as road surface.

### EXAMPLES

The following examples illustrate embodiments of the present invention. All parts and percentages in the examples are by weight unless otherwise indicated. The following materials are used in the examples:

A waterborne epoxy resin XZ92598, available from The Dow Chemical Company, has a solids content of from 63 to 65 wt % and is a nonionic emulsified bisphenol A diglycidyl ether (BADGE), wherein BADGE has an EEW of from 193 to 204.

Donghai 70^{#} asphalt is available from Sinopec.

Asphalt emulsion is an emulsion based on 70^{#} asphalt and is available from Sinopec.

Technical cashew nut shell liquid (“CNSL”) comprises, based on the total weight of CNSL, about 66 wt % of cardanol, about 14 wt % of cardol, and about 20 wt % of polymerized materials according to the GC-FID test method described below.

CNSL-85 comprises, based on the total weight of CNSL, about 83 wt % of cardanol, about 13 wt % of cardol, and about 4 wt % of polymerized materials according to the GC-FID test method described below.

CNSL-90 comprises, based on the total weight of CNSL, about 90 wt % of cardanol, about 7 wt % of cardol, and about 3 wt % of polymerized materials according to the GC-FID test method described below.

CNSL-95 comprises, based on the total weight of CNSL, about 94 wt % of cardanol, about 3 wt % of cardol, and about 3 wt % of polymerized materials according to the GC-FID test method described below.

Technical CNSL, CNSL-85, CNSL-90 and CNSL-95 described above are all available from Huada Saigao (Yantai) Science & Technology Company Limited.

Ethylenediamine, available from SCRC, is an aliphatic amine and has a calculated HLB value of 10.7.

Paraformaldehyde is available from Sinopharm Chemical.

SBR latex 1502 has a solids content of 60 wt % and is available from Shandong Gaoshike Company.

Hydrochloric acid is available from Zhende Chemical.

The following standard analytical equipment and methods are used in the Examples.

### Stability of An Asphalt Emulsion Composition

The stability of an asphalt emulsion composition is determined using a SYD-0655 type stability test equipment according to the T0655-1993 method described in the JTG E20-2011 standard. Two hundred fifty (250) milliliter (ml) of an asphalt emulsion composition is stored in a tube having two outlets under different conditions: (1) 1 day at room temperature (RT), (2) 1 day at 60° C., and (3) 5 days at room temperature, respectively. After storage under a certain condition described above, emulsion samples are collected from each outlet for measuring solids content. For the same storage condition, solids content difference between the emulsion samples from the above two outlets is used to evaluate the stability of the asphalt emulsion composition. An asphalt emulsion composition having satisfactory stability needs to meet all the following requirements:
the difference of solids content of the asphalt emulsion composition between the above two outlets is: (1) less than 1% after one-day storage at room temperature, (2) less than 1% after one-day storage at 60° C., and (3) less than 5% after 5-day storage at room temperature.

### Pull-off Adhesion Strength

A curable asphalt composition or a SBR-modified asphalt emulsion is paved on a concrete board to form a layer. After emulsions break, six dollies are placed onto the surface of the layer. The resulting sample is placed at room temperature for 4-5 days for complete curing to form a tack coat with a thickness of around 1 millimeter (mm) Then, a pull-off tester is employed to measure the pull-off adhesion strength of the tack coat from the concrete substrate at a pulling rate of 300 newtons per second (N/s), at room temperature and 60° C., respectively. Three samples are employed for the pull-off test.

### Tyndall Effect Test

A red laser pointer is held up to one side of a glass cup containing an asphalt emulsion composition, then the laser is turned on to go through the emulsion to observe light scatting effect. The light scattering effect can be used to decide whether the size of emulsion particles in an emulsion is comparable with or larger than light length. If a beam of light is visible when the laser goes through the emulsion composition, it indicates that the emulsion composition shows the Tyndall effect.

### GPC Analysis

CNSL samples are dissolved in tetrahydrofuran (THF) to form a CNSL solution with a concentration of 5 milligrams per cubic meter (mg/m³), and then filtered with 0.45 micrometer (μm) polytetrafluoroethylene (PTFE) filter. Fifty (50) microliters (μl) of the filtered sample is injected into the GPC. The GPC analysis is conducted on Agilent 1200 with two mixed E columns (7.8*300mm) in tandem with column temperature of 40° C., THF as the mobile phase, and an Agilent Refractive Index detector.

### GC-FID Analysis

By using 3-pentadecylphenol (PDP) as calibration standard, the quantification analysis of the concentration of components in CNSL samples is conducted by GC-FID. A standard solution is prepared as follows: about 0.2 grams of PDP is dissolved in about 8 grams of THF to give the PDP standard solution with a concentration of about 2.5 wt %. The resulting standard solution is filtered with 0.45 μm syringe filter before the GC injection. About 0.2 grams of CNSL sample are diluted with about 8 grams of THF. 1 μl of the resulting CNSL solution is injected into the GC after filtered. The analysis is then conducted on Agilent 7890A equipped with FID.

### Example (Ex) 1

### Phenalkamine Composition

The phenalkamine composition of Ex 1 was prepared as follows. A 1-litre round flask was equipped with a Dean-Stark water trap connected to a refluxing condenser, a mechanical stirrer and a nitrogen adapter. 297 grams (1.0 mole) of technical CNSL were mixed with 120.2 grams (2.0 moles) of ethylenediamine; then the mixture was stirred to be homogeneous and heated up to 80° C. With continuous mechanical stirring, mild nitrogen flow and cooling water circulation, 66 grams (2.2 moles) of paraformaldehyde were charged into the flask over a time period of 45 to 60 minutes. Then, 31.9 grams (0.3 mole) of xylene were added to the flask and the flask temperature was raised to 110° C. Water generated during reaction was removed by xylene under azeotropic distillation. When the technical CNSL was consumed up by observing thin layer chromatography (TLC) under 254 nanometer (nm) ultraviolet, the reaction was stopped. The obtained mixture was further treated by rotary evaporation (90° C., 30-50 mbar vacuums) to remove the residue of the azeotrope and volatiles. The resultant product appears black and viscous, having a viscosity of around 5,000 centipoises (cps) (25° C., ASTM D2196) and an amine value of about 330 milligram potassium hydroxide per gram sample (mg KOH/g) (ISO 9702).

### Comparative Example (Comp Ex)

### A Phenalkamine Composition

The phenalkamine composition of Comp Ex A was prepared according to the process described in Ex 1, except CNSL-85 was used instead of the technical CNSL. The resultant product appears black and viscous, having viscosity around 3,000 cps (25° C., ASTM D2196) and an amine value of about 330 mg KOH/g (ISO 9702).

### Comp Ex B

### Phenalkamine Composition

The phenalkamine composition of Comp Ex B was prepared according to the process described in Ex 1, except CNSL-90 was used instead of the technical CNSL. The resultant product appears black and viscous, having viscosity around 2,800 cps (25° C., ASTM D2196) and an amine value of about 330 mg KOH/g (ISO 9702).

### Comp Ex C

### Phenalkamine Composition

The phenalkamine composition of Comp Ex C was prepared according to the process described in Ex 1, except CNSL-95 was used instead of the technical CNSL. The resultant product appears black and viscous, having viscosity around 2,800 cps (25° C., ASTM D2196) and an amine value of about 330 mg KOH/g (ISO 9702).

### Ex 2 and Comp Exs D-F

### Asphalt Emulsion Compositions

Using phenalkamine compositions of Ex 1 and Comp Exs A-C obtained above, asphalt emulsion compositions were prepared based on formulations shown in Table 1. Fifty-five (55) grams of a phenalkamine composition were mixed with 377 grams of water. Hydrochloric acid (HCl) was added to the resultant mixture to adjust pH value to 1.5-2.5 to form an emulsion. The emulsion was then heated to 60-90° C. and poured into a colloid mill. Meanwhile, 510 grams of solid Donghai 70^{#} asphalt was heated to about 140° C. and added into the colloid mill under agitation for 2 minutes to form an asphalt emulsion composition.

The asphalt emulsion compositions of Comp Exs D-F did not exhibit the Tyndall effect. In contrast, the asphalt emulsion composition of Ex 2 showed the Tyndall effect.

Stabilities of the asphalt emulsion compositions obtained above were also evaluated according to the test method describe above and were reported in Table 1. Only the asphalt emulsion composition (Ex 2) comprising the phenalkamine composition of the present invention showed satisfactory stability. In particular, the asphalt emulsion composition of the present invention showed satisfactory stability without the use of any conventional emulsifiers. In contrast, the asphalt emulsion compositions of Comp Exs D-F all did not show satisfactory stability.

TABLE 1

| | | Solids Content Difference of Asphalt | | |
|---|---|---|---|---|
| | | Emulsion Composition | | |
| Asphalt Emulsion | Phenalkamine | <1% after 1 | <1% after 1 | <5% after 5 |
| Composition | Composition used | day at RT | day at 60° C. | days at RT |
| Ex 2 | Ex 1 Phenalkamine | Yes | Yes | Yes |
| Comp Ex D | Comp Ex A Phenalkamine | Yes | No | No |
| Comp Ex E | Comp Ex B Phenalkamine | No | No | No |
| Comp Ex F | Comp Ex C Phenalkamine | No | No | No |

### Ex 3

### Curable Asphalt Composition

One hundred (100) grams of the asphalt emulsion composition (“Part A”) of Ex 2 was further blended with 15 grams of waterborne epoxy XZ92598 (“Part B”) to form epoxy-modified curable asphalt composition of Ex 3.

### Comp Exs G-I

An asphalt emulsion based on 70^{#} asphalt was mixed with SBR latex at a SBR concentration of 4 wt %, 8 wt %, or 10 wt % to form a SBR-modified asphalt emulsion of Comp Exs G, H and I, respectively. Weight percentage of SBR is based on the total weight of the asphalt and solids weight of the SBR latex.

Table 2 shows properties of tack coats made from curable asphalt compositions of the present invention and SBR-modified asphalt emulsions. Compared to the tack coats made from the SBR-modified asphalt emulsions of Comp Exs G-I, the tack coat made from the curable asphalt composition of Ex 3 showed higher pull-off adhesion strength both at room temperature (RT) and at 60° C.

TABLE 2

| | Comp Ex G | Comp Ex H | Comp Ex I | Ex 3 |
|---|---|---|---|---|
| Pull-off | 0.76 | 1.23 | 0.71 | 1.37 |
| adhesion | | | | |
| strength | | | | |
| (megapascals | | | | |
| (MPa), RT) | | | | |
| Pull off | 0.2 ± 0.02 | 0.22 ± 0.02 | 0.2 ± 0.02 | 0.38 ± 0.07 |
| adhesion | | | | |
| strength | | | | |
| (MPa, 60° C.) | | | | |

What is claimed is:

1. A phenalkamine composition, comprising the reaction product of:
(a) an aldehyde,
(b) a polyamine having a hydrophilic-lipophilic balance value of 11 or less, and
(c) cashew nut shell liquid comprising cardol and polymerized materials of cardanol, cardol, or mixtures thereof; wherein the total content of cardol and the polymerized materials is at least 20 wt %, based on the total weight of the cashew nut shell liquid.

2. The phenalkamine composition of claim 1, wherein the polymerized materials have a polystyrene equivalent weight average molecular weight of from 620 to 8000.

3. The phenalkamine composition of claim 1 wherein the total content of cardol and the polymerized materials is from 25 to 60 wt %, based on the total weight of the cashew nut shell liquid.

4. The phenalkamine composition of claim 1 wherein the cashew nut shell liquid also comprises, based on the total weight of the cashew nut shell liquid, from 40 to 80 wt % of cardanol.

5. The phenalkamine composition of claim 1 wherein the polyamine is selected from an aliphatic diamine, an aromatic diamine, a polyamide, a cycloaliphatic polyamine, a polycyclic polyamine, a polyamidoamine, or mixtures thereof.

6. The phenalkamine composition of claim 1 wherein the polyamine is selected from ethylenediamine; diethylenediamine; isophorone diamines; 1,3-cyclohexanebis(methylamine); 4,4′-methylenebis(cyclohexylamine); m-xylylenediamine; or mixtures thereof.

7. The phenalkamine composition of claim 1 wherein the aldehyde is selected from formaldehyde, paraformaldehyde, or mixtures thereof.

8. The phenalkamine composition of claim 1 wherein the molar ratio of cashew nut shell liquid:aldehyde:polyamine is in the range of 1.0: 1.0-3.0:1.0-3.0.

9. A process of preparing the phenalkamine composition of claim 1 comprising:
providing (a) an aldehyde, (b) a polyamine having a hydrophilic-lipophilic balance value of 11 or less, and (c) cashew nut shell liquid comprising cardol and polymerized materials of cardanol, cardol, or mixtures thereof; wherein the total content of cardol and the polymerized materials is at least 20 wt %, based on the total weight of the cashew nut shell liquid; and
reacting the aldehyde, the polyamine, and the cashew nut shell liquid to form the phenalkamine composition.

10. An asphalt emulsion composition, comprising: (i) the phenalkamine composition of claim 1 (ii) at least one acid, (iii) water, and (iv) asphalt.

11. The asphalt emulsion composition of claim 10, wherein the asphalt emulsion composition is substantially free of an emulsifier.

12. The asphalt emulsion composition of claim 10, wherein the asphalt emulsion composition comprises, based on the total weight of the asphalt emulsion composition, from 45 to 65 wt % of the asphalt.

13. The asphalt emulsion composition of claim 10, wherein the asphalt emulsion composition comprises, based on the total weight of the asphalt emulsion composition, from 0.05 to 15 wt % of the phenalkamine composition.

14. A process of preparing the asphalt emulsion composition of claim 10, comprising admixing (i) the phenalkamine composition comprising the reaction product of:
(a) an aldehyde,
(b) a polyamine having a hydrophilic-lipophilic balance value of 11 or less, and
(c) cashew nut shell liquid comprising cardol and polymerized materials of cardanol, cardol, or mixtures thereof; wherein the total content of cardol and the polymerized materials is at least 20 wt %, based on the total weight of the cashew nut shell liquid, (ii) at least one acid, (iii) water, and (iv) asphalt.

15. A curable asphalt composition, comprising:
(A) an asphalt emulsion composition comprising (i) the phenalkamine composition of claim 1 (ii) at least one acid, (iii) water, and (iv) asphalt; and
(B) a waterborne epoxy resin having a solids content.

16. The curable asphalt composition of claim 15, wherein the equivalent ratio of epoxy group in the waterborne epoxy resin to active hydrogen in the phenalkamine composition is from 1:0.5 to 1:2.

17. The curable asphalt composition of claim 15, wherein the weight ratio of solids of the waterborne epoxy resin to the asphalt is from 0.01:1 to 10:1.

18. The curable asphalt composition of claim 15, wherein the curable asphalt composition further comprises aggregates, fillers, stabilizers, curing promoters, or mixtures thereof.

19. A process of preparing the curable asphalt composition of claim 15, comprising admixing (A) an asphalt emulsion composition comprising (i) the phenalkamine composition of any one of claims 1-8, (ii) at least one acid, (iii) water, and (iv) asphalt; and (B) a waterborne epoxy resin having a solids content.

20. The asphalt emulsion composition of claim 12, wherein the asphalt emulsion composition comprises, based on the total weight of the asphalt emulsion composition, from 0.05 to 15 wt % of the phenalkamine composition.
